(19) United States
(12) Patent Application Publication
(10) Pub. No.: US 2016/0315780 A1
(43) Pub. Date: Oct. 27, 2016

(54) METHOD AND SYSTEM FOR CONFIGURING PSE POLARITY

(71) Applicant: Cisco Technology, Inc., San Jose, CA (US)

(72) Inventors: Koussalya BALASUBRAMANIAN, Santa Clara, CA (US); Ken NAUMANN, Livermore, CA (US)

(21) Appl. No.: 14/692,758

(22) Filed: Apr. 22, 2015

(51) Int. Cl. H04L 12/10

(52) U.S. Cl. CPC H04L 12/10

(57) ABSTRACT

In one embodiment a system and method is described, the system and method including a Power Source Equipment (PSE) configured to provide a Powered Device (PD) with a first voltage polarity for power over Ethernet (PoE), the PSE comprising a control module which detects an indication from the PD indicating successful power up of the PD, a PSE voltage generator which continues to send PoE having voltage with the first voltage polarity in response to the PD successfully powering up, the PSE control module being operative to reverse the voltage polarity set by the PSE to be sent to the PD from the first voltage polarity to a second voltage polarity in response to no indication from the PD, thereby indicating a failure of the PD to power up, and the PSE voltage generator being operative to continue to send PoE having voltage with the second voltage polarity in response to the PD successfully powering up. Related methods, systems, and apparatus are also described.

### FIELD OF THE INVENTION

The present disclosure relates generally to Power-over-Ethernet.

### BACKGROUND OF THE INVENTION

A Power-over-Ethernet (PoE) system includes Power Source Equipment (PSE) to provide a PoE voltage over an Ethernet cable to a Powered Device (PD) to power the PD. Conventionally, the PSE supplies the PoE voltage within a limited PoE voltage range, such as 44-57 Volts (V) as defined in the IEEE 802.3 standard. The supplied PoE voltage is generally set to be substantially higher than a voltage actually needed to power circuits in the PD so as to reduce a power transmission loss in the Ethernet cable connecting the PSE to the PD, and thereby reduce the impact of the power transmission loss at the PD. The PD typically includes a Direct Current-to-Direct Current (DC-DC) voltage converter to convert the higher voltage down to a lower voltage useable by the circuits in the PD, such as 5V or 12V. The DC-DC voltage down-conversion incurs a DC-DC power efficiency conversion loss in the PD. Typical cable runs over which PoE can provide power are as long as 100 meters.

The IEEE 802.3 standard defines voltage polarity in PoE systems. Ethernet cable (by way of example, RJ45 cat 5 cable) utilizes twisted pair cable with differential data transmission over each pair of transformer coupling. The DC supply and load connections are typically made to the transformer center-taps at each end. Each pair of the twisted pair cable operates in common mode as one side of a DC power supply. Thus, two pairs of the twisted pair cable are required to complete the circuit. The polarity of the DC supply may be inverted by crossover cables. The powered device must operate with either pair: spare pairs 4-5 and 7-8 or data pairs 1-2 and 3-6.

### BRIEF DESCRIPTION OF THE DRAWINGS

The present invention will be understood and appreciated more fully from the following detailed description, taken in conjunction with the drawings in which:

FIG. 1 is a flowchart of a method for dynamically configuring power supplying equipment (PSE) polarity in a power over Ethernet (PoE) constructed and operative in accordance with an embodiment;

FIG. 2 is a flowchart of a method for a powered device (PD) receiving power, the polarity of which may be configured dynamically at the PSE; and

FIGS. 3A-3C are simplified block diagrams of a switch implemented at the PSE for dynamically configuring polarity of power supplied by the PSE.

### DESCRIPTION OF EXAMPLE EMBODIMENTS

### Overview

In an exemplary embodiment, a system and method is described, the system and method including, a Power Source Equipment (PSE) configured to provide a Powered Device (PD) with a first voltage polarity for power over Ethernet (PoE), the PSE comprising a control module which detects an indication from the PD indicating successful power up of the PD, a PSE voltage generator which continues to send PoE having voltage with the first voltage polarity in response to the PD successfully powering up, the PSE control module being operative to reverse the voltage polarity set by the PSE to be sent to the PD from the first voltage polarity to a second voltage polarity in response to no indication from the PD, thereby indicating a failure of the PD to power up, and the PSE voltage generator being operative to continue to send PoE having voltage with the second voltage polarity in response to the PD successfully powering up. Related methods, systems, and apparatus are also described.

### Exemplary Embodiment

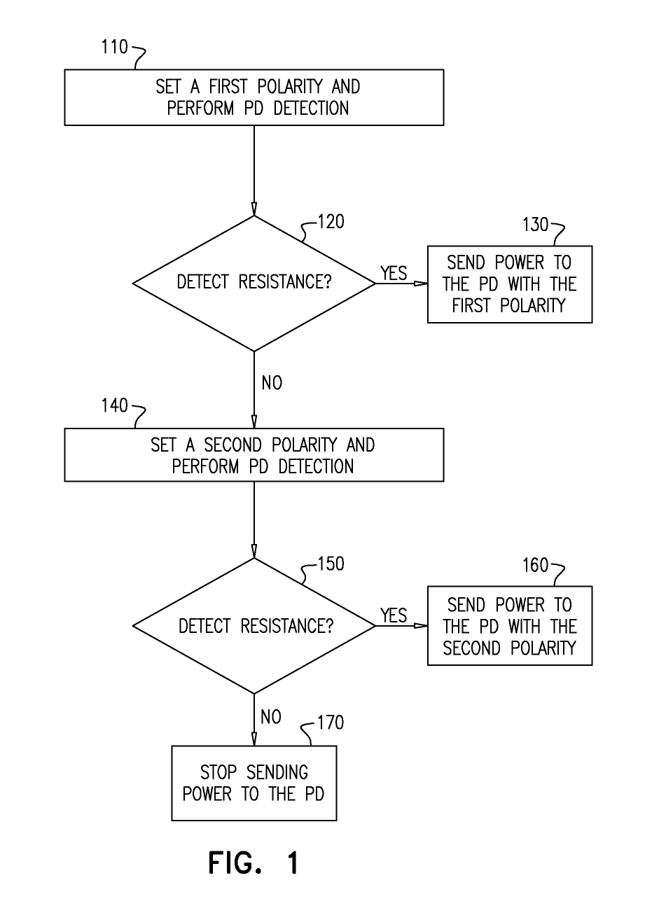

Reference is now made to FIG. 1, which is a flowchart of a method for dynamically configuring power supplying equipment (PSE) polarity in a power over Ethernet (PoE) constructed and operative in accordance with an embodiment. An IEEE standard, IEEE 802.at, specifies polarity insensitive behavior for powered devices (PD) (i.e. the PD will operate regardless of the polarity of the powering voltage input). Legacy PDs, however, may require power which is provided at a specific polarity rather than being polarity insensitive as specified by the IEEE 802.at standard. As such, an IEEE 802.at compliant switch may not successfully power up a legacy, non-IEEE 802.at compliant, PD.

Additionally, PDs are typically more significantly cost sensitive than PSE. As such, manufacturers of PDs attempt to reduce costs by removing costly components, such as diode bridges. While designing PDs without diode bridges has the effect of improving PD efficiency, once the diode bridges are no longer present in the PD, the PD will not be polarity insensitive, and thus, no longer compliant with the IEEE 802.at standard.

The PSE and the PD comprise standard components, which are well known in the art. By way of example, the PSE may typically comprise a voltage generator, a power supply, various voltage sources, a PSE control module. a processor, memory, Ethernet (RJ 45) ports, and so forth. The PD may typically comprise Ethernet (RJ 45) ports, a processor, memory, and so forth.

There are two modes used to implement PoE. In what is commonly referred to as mode A, PoE is provided over two pairs of twisted pair cable of the pairs of cables on a CAT 3 or, more typically, CAT 5 RJ 45 (i.e., Ethernet) cable. In mode A, the two pairs of twisted pair cable are data pairs. On the other hand, in mode B, while PoE is provided over two pairs of twisted pair cable, the PoE is delivered over the spare pairs of twisted pair cables.

In some implementations of PoE (such as the Universal Power over Ethernet (UPOE)) implementation, all four pairs of twisted cable are utilized for PoE delivery. However, a PD which is not polarity insensitive may appear as a short circuit for the 4-pair PSE. However, if the PSE is able to detect the short circuit and dynamically change its own polarity, then the PSE will be able to enable the PD.

During power up of a PoE link, the PSE detects if the PD has a resistance in a signature range (i.e. 19-26.5 kΩ), indicating that the PD is a PoE enabled device. As is known in the art, the PSE performs this detection by sending a low voltage (between 2.7-10.1 V) during power up. During this stage of power up, the PSE sets a first polarity to send to the PD (step 110). In standard PoE systems, the PSE then detects a resistor at the PD which indicates a power range that the PD needs the PSE to provide in order for the PD to operate correctly. In the present embodiment, the PSE may detect resistance, indicating the presence of such a resistor (step 120). In that case, the PSE will send power within the range indicated by the resistor with the first polarity to the PD (step 130). However, if no such resistor is detected, then the PSE will try detection again on the PD with a second polarity (step 140). If a valid PD is found with the second polarity (i.e. the PSE now detects resistance, step 150), then PSE will send power within the range indicated by the resistor with the second polarity (step 160). The second polarity will be the opposite polarity of the first polarity. Should the PSE not detect the resistor at this stage, then the PSE will stop providing power to the PSE (step 170).

Once a polarity for the power has been negotiated between the PSE and the PD using the method described above, the PoE power up procedure continues through the remaining steps (i.e. the PSE providing startup voltage, and the PSE providing power to the PD).

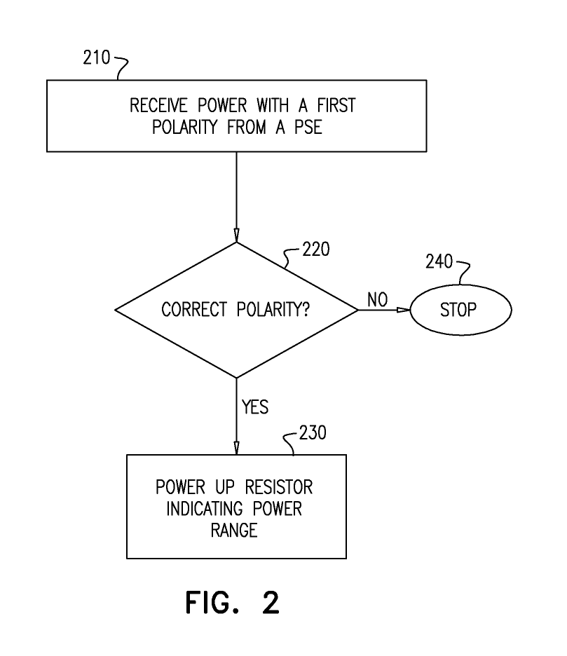

Reference is now made to FIG. 2, which is a flowchart of a method for the PD receiving power, the polarity of which may be configured dynamically at the PSE. The PD receives power with the first polarity from the PSE (step 210). If the power received with first polarity is the polarity required by the PD in order to operate correctly (step 220), then the PD continues to power up by powering up the resistor indicating the power range that the PD needs the PSE to provide in order for the PD to operate properly (step 230). On the other hand, if the first polarity is not the polarity required by the PD in order to operate correctly, the PD does not power up (step 240). At this point the above method may then be repeated, this time with power with the second polarity sent by the PSE.

The above description is written for the case when the method described above occurs at the detection phase of PD power up. It is appreciated that the method described above may, alternatively, occur during PD start up. In this embodiment of the above method which occurs at PD start up, the failure of the PD to draw power from the PSE is indicative that the PSE is providing power in the incorrect polarity.

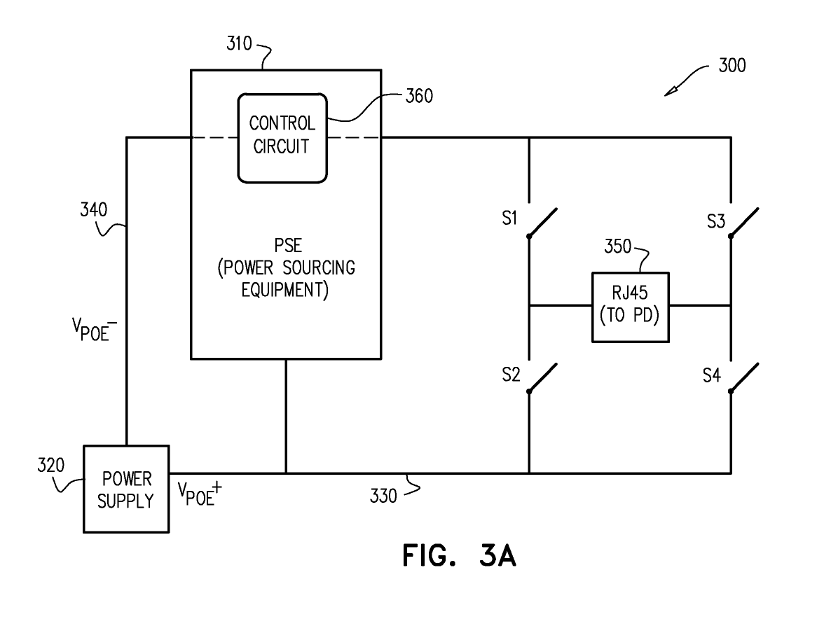

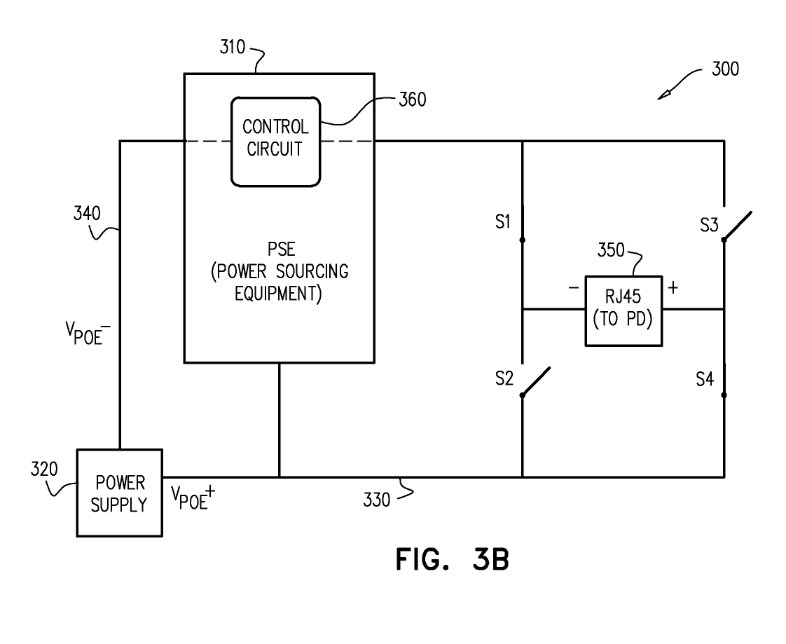

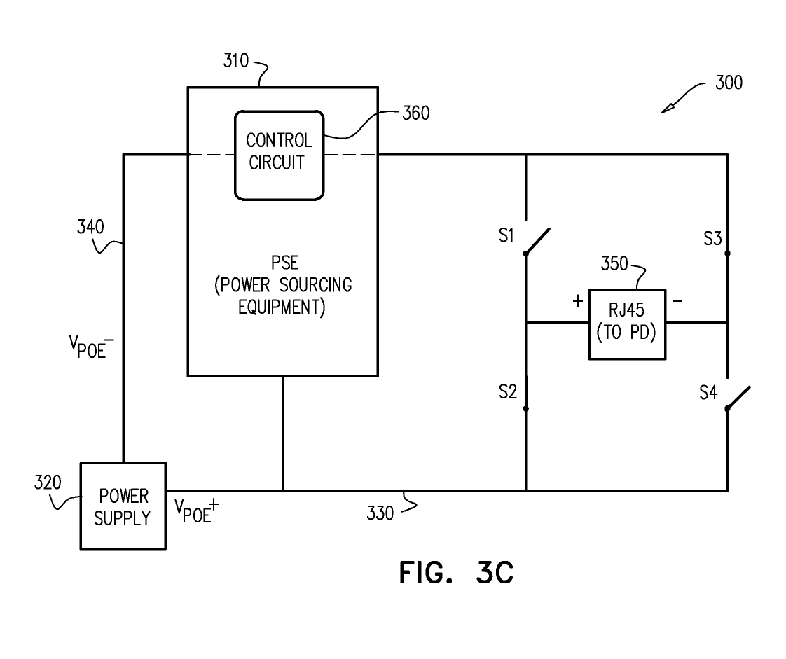

Reference is now made to FIGS. 3A-3C, which are simplified block diagrams of a switch 300 implemented at the PSE 310 for dynamically configuring polarity of power supplied by the PSE 310. A power supply 320 provides the main PoE voltage. A first rail, identified as a V_{PoE}+ rail 330 of a circuit has positive voltage. Similarly, a second rail, identified as a V_{PoE}− rail 340 of the circuit has negative voltage. The PSE 310 performs the PSE operations described above, as well as other PSE operations which are well known in the art (such as detection, classification, voltage turn on, current control, and so forth, The RJ 45 (i.e., Ethernet) 350 connector is, as mentioned above, typically a CAT 5 Ethernet cable comprising an 8-pin connector that carries power and data to an end load, described above as the PD (not depicted).

Switches S1, S2, S3, and S4 are four control switches that determine the polarity of voltage fed to RJ45.

In FIG. 3A, all of the switches are depicted as open, for ease of discussion. In FIG. 3B, switches S1 and S4 are closed, and switches S2 and S3 are open. The polarity of the voltage is depicted, in this case, as being − (negative) on the left side of the diagram (i.e. depicted on the left side of the RJ 45 connector 350) and + (positive) on the right side of the diagram (i.e. depicted on the right side of the RJ 45 connector 350).

In FIG. 3C, switches S2 and S3 are closed, and switches S1 and S4 are open. The polarity of the voltage is depicted, in this case, as being + (positive) on the right side of the diagram (i.e. depicted on the right side of the RJ 45 connector 350 and − (negative) on the left side of the diagram (i.e. depicted on the left side of the RJ 45 connector 350.

Persons of skill in the art will appreciate that there are many ways in which the switches S1-S4 can be designed using, for instance, MOSFETs (metal-oxide-semiconductor field-effect transistors), relays etc.

The PSE 310 comprises a control circuit 360 which enables or disables the switches S1-S4. Persons of skill in the art will appreciate that the control circuit 360 may be fashioned in a variety of ways, and may be included in the PSE 310. Alternatively, the control circuit 360 may comprise a separate control block (not depicted).

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A method comprising:
setting a first voltage polarity for power over Ethernet (PoE) by a Power Source Equipment (PSE) configured to provide PoE to a Powered Device (PD);
detecting an indication from the PD indicating successful power up of the PD;
in response to the PD successfully powering up, continuing to send PoE having voltage with the first voltage polarity;
in response to no indication from the PD, thereby indicating a failure of the PD to power up, reversing the voltage polarity set by PSE to be sent to the PD from the first voltage polarity to a second voltage polarity; and
in response to the PD successfully powering up, sending PoE having voltage with the second voltage polarity.

2. The method according to claim 1 wherein the steps of reversing the polarity and sending the PoE with the reversed polarity is performed during PoE detection.

3. The method according to claim 1 wherein the steps of reversing the polarity and sending the PoE with the reversed polarity is performed during PoE startup.

4. The method according to claim 1 wherein in response to a failure of the PD to power up after the sending of the PoE with the second voltage polarity, the PSE stops trying to provide power to the PD.

5. The method according to claim 1 wherein the indication from the PD indicating successful power up comprises detection of a resistor indicating a PoE power range.

6. The method according to claim 1 wherein the indication from the PD indicating successful power up comprises detection of the PD drawing full PoE power from the PSE.

7. The method according to claim 1, and further comprising during the step of setting the first voltage polarity for PoE by the Power Source Equipment PSE, setting a switch comprised in the PSE to provide voltage having the first voltage polarity; and
reconfiguring the switch to provide voltage in the second voltage polarity during the step of reversing the voltage polarity.

8. The method according to claim 7, wherein the PSE further comprises a control circuit to control the state of said switch.

9. The method according to claim 7 wherein said switch comprises metal-oxide-semiconductor field-effect transistors (MOSFETs).

10. The method according to claim 7 wherein said switch comprises a relay.

11. A system comprising:
a Power Source Equipment (PSE) configured to provide a Powered Device (PD) with voltage, the voltage having a first voltage polarity for power over Ethernet (PoE), the PSE comprising a control module which detects an indication from the PD indicating successful power up of the PD;
a PSE voltage generator which continues to send PoE having voltage with the first voltage polarity in response to the PE successfully powering up;
the PSE control module being operative to change polarity of the voltage to be sent by the PSE to the PD from the first voltage polarity to a second voltage polarity in response to the control module not detecting an indication from the PD, thereby indicating a failure of the PD to power up; and
the PSE voltage generator being operative to continue to send PoE having voltage with the second voltage polarity in response to the PD successfully powering up.

12. The system according to claim 11 wherein the PoE polarity is reversed and the PoE with the reversed polarity is sent during PoE detection.

13. The system according to claim 11 wherein the PoE polarity is reversed and the PoE with the reversed polarity is sent during PoE startup.

14. The system according to claim 11 wherein in response to a failure of the PD to power up after the reversal of the polarity of the voltage sent to the PD, the PSE stops trying to provide power to the PD.

15. The system according to claim 11 wherein the indication from the PD indicating successful power up comprises detection of a resistor indicating a POE power range.

16. The system according to claim 11 wherein the indication from the PD indicating successful power up comprises detection of the PD drawing full PoE power from the PSE.

17. The system according to claim 16, wherein the PSE comprises a configurable switch set which provides voltage having the first voltage polarity during the step of setting the first voltage polarity for PoE by the Power Source Equipment PSE, and which provides voltage in the second voltage polarity during the step of reversing the voltage polarity.

18. The system according to claim 17, wherein the PSE further comprises a control circuit to control the state of said switch.

19. The system according to claim 17 wherein said switch comprises metal-oxide-semiconductor field-effect transistors (MOSFETs).

20. The system according to claim 17 wherein said switch comprises a relay.
